(19) United States
(12) Patent Application Publication
(10) Pub. No.: US 2025/0134152 A1
(43) Pub. Date: May 1, 2025

(54) CELLULOSE-BASED POWDERED FIBER SUPPLEMENTS AND METHODS OF PREPARING SAME

(71) Applicant: International N&H USA, Inc., Wilmington, DE (US)

(72) Inventors: JEANNINE FRANCES DELWICHE, FAIRLESS HILLS, PA (US); MICHAEL KURT CAMMARATA, FALLSINGTON, PA (US); ROSS ALLEN WHITE, DAYTON, NJ (US); MARSHALL COREY FONG, PHILADELPHIA, PA (US)

(21) Appl. No.: 19/009,423

(22) Filed: Jan. 3, 2025

Related U.S. Application Data
(63) Continuation of application No. 16/245,894, filed on Jan. 11, 2019, now abandoned.
Application No. 16/245,894 is a continuation of application No. 15/723,954, filed on Oct. 3, 2017, now abandoned.
(60) Provisional application No. 62/552,597, filed on Aug. 31, 2017.

(51) Int. Cl. A23L 33/24; A23L 2/52; A23L 29/206; A23L 29/231; A23L 29/238; A23L 29/25; A23L 29/262

(52) U.S. Cl. CPC A23L 33/24; A23L 2/52; A23L 29/206; A23L 29/231; A23L 29/238; A23L 29/25; A23L 29/262; A23V 2002/00

(57) ABSTRACT

Consumption of dietary fiber supplements can be unpleasant due to the perception of grittiness, sliminess, and/or sharpness of the supplement when consumed. The present invention describes a composition suitable for use in a dietary fiber supplement, the composition comprising (i) a water insoluble fiber (insoluble fiber) and (ii) a hydrocolloid combined in a ratio that provides a surprisingly palatable mixture in water.

### CROSS-REFERENCE TO RELATED APPLICATIONS

This application is a Continuation of U.S. patent application Ser. No. 16/245,894 filed Jan. 11, 2019, which is a Continuation of U.S. patent application Ser. No. 15/723,954 filed Oct. 3, 2017, which claims priority of U.S. Patent Application 62/552,597 filed Aug. 31, 2017, the contents of all three applications are incorporated herein by reference in their entirety for all purposes.

### FIELD OF THE INVENTION

The present invention relates to dietary supplements. The present invention particularly relates to dietary fiber supplements.

### BACKGROUND OF THE INVENTION

Fiber is a necessary component of a healthy human diet—so much so that a government recommendation for daily dietary fiber intake has been established. In 2017, according to the United States Food and Drug Administration (FDA), the recommended daily value (DV) for fiber is between 25 grams (for women) and 30 grams (for men) per day, based on a 2,000 calorie diet. The individualized DV may be higher or lower depending upon the caloric needs of the individual. The FDA recommends consumption of 100% of the DV. (https://www.accessdata.fda.gov/scripts/InteractiveNutritionFactsLabel/dietary-fiber.html).

Diets that are high in fiber are considered to promote improved heart health. Food sources that are high in fiber include split peas, lentils, black beans, artichokes and raspberries. Dietary fiber can be divided into two types: soluble fiber (which dissolves in water) and insoluble fiber (which does not dissolve in water). Soluble fiber tends to form a gel during digestion and will actually slow the digestive process. Slowing digestion can help regulate blood sugar. Soluble fiber can also help reduce LDL (bad) cholesterol. Soluble fiber is found naturally in oatmeal, flax seed, barley, dried peas, oranges, apples and carrots.

Insoluble fiber does not dissolve in water and is not digestible by humans. Insoluble fiber adds bulk to the stool causing it to move through the digestive system quickly, which relieves constipation. Insoluble fiber helps to balance the pH in the intestines and helps prevent colon cancer. Natural sources of insoluble fiber are seeds, nuts, dark green leafy vegetables, and wheat bran.

Unfortunately most Americans consume less than half of the daily amount of fiber recommended by the FDA. For this reason, some choose to use available fiber supplements. Fiber supplements can provide relief from constipation and bowel irregularity, as well as help with weight management by providing a feeling of fullness for longer periods of time. Although FDA guidelines that define what is considered fiber are under review in 2017 at the time of filing of this application, fiber supplements available to the consumer under the current FDA guidelines include, for example: Inulin (sold under the name Fiber Choice®), which is 100% soluble fiber and is prebiotic, i.e., it causes significant favorable changes in the colon bacterial population; methylcellulose (sold under the name of Citrucel® or SmartFiber®), which is 100% soluble fiber made from cellulose; psyllium, also known as ispaghula (sold under the name of Metamucil®), which is obtained from seed husks of the plantago ovate plant, and is 70% soluble fiber and does contain some insoluble fiber; and wheat dextrin (sold under the name of Benafiber®), which is 100% soluble fiber (http://www.healthline.com/health/digestive-health/whats-the-best-fiber-supplement #1).

The top selling fiber supplements are generally considered to be of low palatability. The primary complaints of consumers generally tend to refer to the “grittiness” of the supplement. Moreover, a few minutes after mixing most fiber supplement with water, the product thickens into a soft, or “broken,” gel which can feel “slimy” or “sludgy”. Thus, the benefits of fiber may be lost to many who do not enjoy the taste of currently available fiber supplements and who are unwilling to modify their diets.

Furthermore, there are few palatable fiber supplements that offer the benefits of an insoluble fiber. There continues to be a need for a fiber supplement having a substantial portion of insoluble fiber that can be consumed readily in a palatable form.

Cellulose, an insoluble dietary fiber, is a natural polysaccharide which is a long chain of monosaccharide units bound together by glycosidic linkages. It is an important structural component of the cell wall of green plants and is the most abundant polysaccharide on Earth. Cellulose can be isolated from its original plant source by conventional pulping processes. This extracted cellulose powder contains both amorphous and crystalline structures. Cellulose powder can be further refined into microcrystalline cellulose (MCC) by removing the amorphous structure; this refinement is most typically achieved using acid hydrolysis.

Cellulose powder is insoluble in water and generally recognized as safe (GRAS). It is used as a replacement for preservatives such as sodium nitrite, and is used to prevent coagulation in products like shredded cheese; it is useful as an emulsifier, bulking agent, or fat substitute. As a bulking agent, it can perform the role of a dietary fiber in providing a feeling of fullness.

Microcrystalline cellulose is also generally recognized as safe and has been extensively used conventionally in various food, pharmaceutical products and nutraceutical products. For example, MCC has been used as a texturizer, an anti-caking agent, a fat substitute, an emulsifier, an extender, and a bulking agent in food production. MCC is often used in vitamins and tablets.

Fiber supplements are available that include cellulose as one of the available sources of fiber. For example, a few available fiber supplements provide fiber in the form of cellulose but do not offer a source of soluble fiber. Other fiber supplements with cellulose-based fiber also include other fiber sources and/or other components that do not increase the palatability of the supplement.

As mentioned above, dietary fiber supplements, generally, can inherently present a problem with perceived “grittiness.” An additional challenge with insoluble fiber is that since it does not dissolve in water, the particles of insoluble fiber are easily felt and can feel sharp and rough in the mouth. Fiber supplements made with cellulose powder or MCC leave sharp, rough particles in the mouth when the delivery vehicle is water, the most common delivery vehicle for fiber supplements.

Existing fiber supplements that include a combination of soluble and insoluble fiber can have a tendency to thicken over time after mixing with water, which results in an increase in the “sludginess” of the supplement. Thus, while these fiber supplements meet the functional requirements, they sacrifice aesthetic and sensory characteristics that make a supplement more palatable. As a result, most commercial fiber supplements have the problem of being perceived as gritty, slimy or sludgy—generally not very palatable.

It can be desirable to provide insoluble dietary fiber as a supplement in a palatable form, and thereby encourage consumption of dietary fiber supplements in support of improved health.

### SUMMARY OF THE INVENTION

In one aspect the present invention is a powdered composition suitable for use in a dietary fiber supplement, the composition comprising:
(i) a cellulose-based fiber; and
(ii) a hydrocolloid;
   wherein the cellulose-based fiber (i) and the hydrocolloid (ii) are combined in a weight ratio in the range of from about 4:1 to about 1:4; and,
   wherein the cellulose-based fiber is an insoluble fiber.

In one aspect the present invention is a powdered composition suitable for use in a dietary fiber supplement, the composition comprising:
(i) a cellulose-based fiber; and
(ii) a hydrocolloid;
   wherein the cellulose-based fiber (i) and the hydrocolloid (ii) are combined in a weight ratio in the range of from about 4:1 to about 1:4; and wherein, upon mixing with water, the composition does not exhibit a substantial increase in viscosity five minutes after mixing.

In another aspect the present invention is a composition suitable for use as a dietary fiber supplement, the composition comprising:
(i) a cellulose-based fiber;
(ii) a hydrocolloid; and
(iii) water,
   wherein the cellulose-based fiber (i) and the hydrocolloid (ii) are combined in a weight ratio in the range of from about 4:1 to about 1:4, wherein the cellulose-based fiber is an insoluble fiber, and wherein, when the viscosity of the composition is measured five minutes after mixing with water, the composition has a viscosity that is substantially the same as its initial viscosity.

In another aspect the present invention is a composition suitable for use as a dietary fiber supplement, the composition comprising:
(i) a cellulose-based fiber;
(ii) hydrocolloid; and
(iii) water,
   wherein the cellulose-based fiber (i) and the hydrocolloid (ii) are combined in a weight ratio in the range of from about 1:1 to about 1:3 (cellulose fiber:hydrocolloid), and wherein the viscosity of the composition measured five minutes after mixing is substantially the same as its initial viscosity.

In another aspect, the present invention is a powdered composition suitable for use in a dietary fiber supplement, the composition comprising:
(i) a cellulose-based insoluble fiber;
(ii) a soluble fiber;
   wherein the cellulose-based insoluble fiber (i) and the soluble fiber (ii) are combined in a weight ratio in the range of from about 4:1 to about 1:4.

In another aspect, the present invention a fiber mixture, wherein the fiber mixture is a blend consisting essentially of: a cellulose-based insoluble fiber and a hydrocolloid fiber, wherein the insoluble fiber comprises about 50 wt % or less of the fiber mixture.

In another aspect, the present invention is a composition comprising:
(i) a cellulose-based fiber;
(ii) a hydrocolloid; and
(iii) water;
   wherein:
(a) the cellulose-based fiber (i) and the hydrocolloid (ii) are combined in a weight ratio in the range of from about 4:1 to about 1:4;
(b) the cellulose-based fiber is an insoluble fiber;
(c) the composition has a viscosity in the range of from about 5 to about 20 cps.

In another aspect, the present invention is a composition consisting essentially of:
(i) microcrystalline cellulose;
(ii) a hydrocolloid;
(iii) water; and
(iv) optional additives selected from acidulants, fruit powders, sweeteners, colorants, bulking agents, and flavorings;
   wherein:
(a) the microcrystalline cellulose (i) and the hydrocolloid (ii) are combined in a weight ratio in the range of from about 4:1 to about 1:4;
(b) the composition has a viscosity in the range of from about 5 to about 20 cps.

### BRIEF DESCRIPTION OF THE DRAWINGS

FIG. 1 is a scale used to measure the perceived intensity of “sliminess” and “grittiness” of MCC alone, guar gum alone, and combinations of MCC and guar.

FIG. 2 is a chart showing the perceived intensity of “sliminess” and “grittiness” of samples of MCC alone, guar gum alone, and a 1:1 combination of MCC and guar.

FIG. 3 is a graph of the intensity of the perceived intensity of “sliminess” and “grittiness” of combinations of MCC and guar in various ratios.

### DETAILED DESCRIPTION OF THE INVENTION

In one embodiment, the present invention is a composition comprising or consisting essentially of (i) a water insoluble fiber (insoluble fiber) and (ii) a hydrocolloid combined in a ratio that provides a surprisingly palatable mixture in water. In the practice of the present invention, the primary source of the insoluble fiber is a cellulose-based water-insoluble fiber. Cellulose powder and/or microcrystalline cellulose are the preferred sources of insoluble fiber in the practice of the present invention.

Hydrocolloids suitable for use in the present application can be selected from: guar gum; gum acacia; beta-glucan soluble fiber; pectin; locust bean gum; hydroxypropylmethylcellulose; agar; alginates; propylene glycol alginate; carrageenan; starch; xanthan; gellan; konjac gum; dextran; pullulan; ghatti; karayan gum; fullcellaran; larch gum; tara gum; tamarind seed gum; tragacanth; curdlan; carboxymethylcellulose (CMC); methylcellulose (MC); ethylcellulose (EC); hydroxypropylcellulose (HPC); Na-CMC—cellulose gum; arabinoxylan; curdlan; and gelatin; or mixtures of any of these.

Preferred hydrocolloids are hydrocolloids that are also classified as fiber, such as: guar gum; gum acacia (also known as acacia gum, gum arabic, arabic gum); beta-glucan soluble fiber; pectin; locust bean gum; hydroxypropylmethylcellulose and any other hydrocolloid material that is defined as a fiber under the current or future FDA guidelines, or mixtures of any of these. Gum acacia and guar gum—also known as guaran, jaguar gum, guar flour—can be particularly suitable for use; guar gum can be particularly effective in the practice of the present invention.

Low viscosity hydrocolloids can be preferred, such as low viscosity guar gum, for example. Low viscosity guar gum is guar gum having a viscosity below about 50 cps, or below about 30 cps, or below about 15 cps.

The fiber supplement composition as described herein comprises a combination of a water-insoluble fiber, a hydrocolloid, and can include optional components such as, for example: acidulants, fruit powders, sweeteners, colorants, bulking agents, and flavorings. Due to the sensory nature of the invention, various combinations and proportions of optional components with the claimed insoluble fiber and hydrocolloid mixture can be used to provide a number of sensory experiences to the consumer. It is reasonable that one of ordinary skill would be able to provide a variety of combinations of flavors, colors, etc., without departing from the scope of the claimed invention.

One of the basic and novel features of the present invention is to provide a fiber supplement comprising a cellulose-based insoluble fiber in a more palatable product. It is an object of the present invention, therefore, to exclude components from the claimed composition that can diminish the palatability of the claimed composition, or to otherwise mask the undesirable properties of any added components. That is, it can be an object of the present invention to exclude components that increase the perception of, for example, grittiness, sludginess and/or sliminess, or otherwise diminishes other desirable properties of the claimed composition. Some products can include components that are intended to mask the undesirable properties contributed by other components, but also contribute to the overall low palatability of the product. Therefore, a balance should be struck between certain desirable and undesirable properties.

For example, the present invention includes soluble fiber and insoluble fiber combined in ratios that balance the perceived grit of one component versus the perceived sliminess or sludginess of the other. If either is out of balance the palatability of the supplement can be reduced. It can also be desirable to exclude some other components that negatively impact the balance of properties obtained by the present invention, such as additional fiber sources and/or other components that add grit or perceived sludginess, bad taste, or poor product consistency, for example.

Viscosity of a food or beverage can influence whether that food or beverage is palatable to a consumer, although viscosity may not be the determinative factor. While the viscosity of a food or beverage comprising a fiber supplement of the present invention may not be solely determinative of the palatability of said food or beverage, in some cases it can be preferred that the initial viscosity of a dispersion of a fiber supplement of the present invention in an aqueous medium be something that is acceptable to a consumer. For the purposes of the present invention, an initial viscosity of less than about 50 cps is suitable. Alternately, an initial viscosity of less than about 40 cps, or less than about 30 cps, or less than about 20 cps is suitable for a supplement of the present invention.

An increase in viscosity of a fiber supplement can be perceived as increased sliminess or sludginess. Components that can tend to increase the viscosity, especially those that continue to thicken over time, can be limited in the claimed composition or excluded altogether in order to avoid an undesirable viscosity increase and, potentially, a perceived increase in the sliminess and/or sludginess of a supplement of the present invention.

Depending upon the type of soluble fiber included herein, a viscosity increase can result after the fiber supplement is mixed with water or other vehicle for the fiber. A substantial viscosity increase can be undesirable with regard to the palatability of a supplement of the present invention. A powdered fiber mixture of the present invention, when mixed with a vehicle such as water, does not substantially increase the viscosity of the vehicle. For the purposes of the present invention, a substantial change in viscosity is a change of greater than about ±10 cps; a change in viscosity that is not substantial is a change of less than about ±10 cps, or less than about ±5 cps, or less than about ±3 cps of the viscosity of the vehicle.

Even if an increase in viscosity is not perceptible to a consumer or is otherwise not substantial, it can be preferred in any case that the maximum viscosity of a fiber supplement of the present invention is less than about 100 cps, or alternatively less than about 50 cps, or alternatively less than about 20 cps, or alternatively less than about 15 cps.

In one embodiment, the present invention is a water-based mixture comprising a fiber supplement as described herein, wherein the the viscosity of the mixture is in the range of from about 5 to about 30 cps, or alternatively from about 5 to about 20 cps, or alternatively from about 5 to about 15 cps.

In one embodiment of the present invention, the present invention consists essentially of a soluble fiber and an insoluble fiber, wherein the insoluble fiber comprises about 50 wt % of the total fiber in the mixture or less. The insoluble fiber can comprise about 33 wt % of the fiber mixture or less, or about 25 wt % of the fiber mixture or less, or about 20 wt % of the fiber mixture or less. The soluble fiber can be a hydrocolloid fiber, and can comprise 50 wt % or more of the total fiber content of the mixture.

It is also an object of the present invention to provide a portion of the daily recommended value of fiber in a fiber supplement. In the practice of the present invention, the amount of fiber in 8 ounces can be up to about 50% of the DV recommended by the FDA, that is, up to about 15 gram/daily for men and up to about 13 grams/daily for women. Alternatively, the amount of total fiber in 8 ounces can be up to about 30%, or about 25%, or about 20% of the DV recommended by the FDA. It can be preferred that the dosage of total fiber in 8 ounces of water is approximately from about 0.1 to about 5 wt % (0.237 to 11.83 grams in 8 ounces of water); or from about 1 to about 4 wt %, or from about 1.5 to about 3.5 wt %.

In some embodiments, the hydrocolloid may be one that is classified by the FDA as a water-soluble fiber. In the practice of the present invention, hydrocolloid fibers and non-fiber hydrocolloids can be functionally equivalent in providing a palatable supplement for insoluble cellulose fiber. Therefore the term “hydrocolloid” as used herein can refer to: (a) hydrocolloids that are classified as fiber; (b) hydrocolloids that are not classified as fiber; and (c) materials that are functional equivalents of hydrocolloids suitable for use in the practice of the present invention. By “functional equivalents” it is meant that any material that masks the sharpness of insoluble cellulose fibers and thereby provides a more palatable insoluble fiber supplement is a “functional equivalent” for the hydrocolloid component. For example, some soluble fibers can be functional equivalents of hydrocolloids in the practice of the present invention.

In the practice of the present invention, sharpness that would typically be detected by a consumer of an insoluble fiber such as MCC or cellulose powder in a fiber supplement is substantially reduced or eliminated when a hydrocolloid or its functional equivalent is combined with MCC.

In one embodiment, the insoluble fiber component is mixed with the hydrocolloid to form a powdered mixture of insoluble fiber and the hydrocolloid. The powder can further comprise optional components such as colorants, flavorings, bulking agents, sweeteners, acidulants, or mixtures of any of these.

In another embodiment, it has been found that a mixture of low viscosity guar gum and water is substantially tasteless; the mixture substantially has the appearance and the properties of water. Low viscosity guar gum can be substantially imperceptible to the human senses when mixed with water. Surprisingly, it has been discovered by the applicants that the combination of the water-like hydrocolloid mixture with an insoluble fiber such as MCC, cellulose powder, or a mixture thereof has substantially reduced sharpness detected in solutions of MCC or cellulose powder alone.

When the total fiber content of a fiber supplement is insoluble fiber—for example, MCC—the mixture has reduced palatability because of the sharpness and/or powdery feel of the mixture. It has been found, surprisingly, that when a hydrocolloid of the present invention is combined with MCC in water the perceived grittiness of the mixture is substantially reduced and, as a result, the reticence for a consumer to consume the supplement mixture can be reduced or completely overcome.

In the practice of the invention, surprisingly, it has been found that if the insoluble fiber is co-processed in a first step with a first hydrocolloid to obtain a powder, followed by mixing the powder with additional hydrocolloid in a subsequent step, palatability of a fiber supplement as described herein can be improved even more. Therefore, it can be of added benefit to co-process insoluble fiber with a first hydrocolloid in a first process step. “Co-processed”, in the practice of the present invention, means to form an intimate admixture of the insoluble fiber and the first hydrocolloid. Mixing can be accomplished by controlled agitation using conventional high-shear equipment such as mills, blenders, homogenizers and similar high-shear mixing equipment. The process can be carried out at room temperature, but temperature variation is contemplated depending on what controllable conditions can be modified to improve the efficiency of the process.

In this embodiment, the weight ratio of the insoluble fiber should be from about 60 to about 99 wt % of the co-processed mixture prior to adding the additional hydrocolloid. Alternatively, the insoluble fiber can be from about 70 to about 95 wt % of the coprocessed mixture; the first hydrocolloid can be from about 1 to about 40 wt %, or about 5 to about 30 wt % of the coprocessed mixture. Coprocessed mixtures can be obtained from an aqueous medium having from about 1 to about 60 wt % solids, based on the weight of the aqueous medium.

A slurry can be formed from the mixture, but in any event the coprocessed mixture of insoluble fiber and first hydrocolloid is dried by conventional methods, such as spray drying for example, to provide the powdered coprocessed fiber/hydrocolloid mixture suitable for combination with additional hydrocolloid as described herein. The additional, or second, hydrocolloid added in the subsequent step can be the same or different from the first hydrocolloid added in the first step. The first hydrocolloid can be selected from any of those described herein, or a mixture thereof. For example, U.S. Pat. No. 5,192,569 describes an MCC powder suitable for use in the practice of the present invention, wherein the MCC powder is intimately admixed with a galactomannan gum.

By way of illustration, if insoluble fiber and first hydrocolloid are first coprocessed in a ratio of more than about 4:1 (fiber to hydrocolloid)—or more than about 5:1, or more than about 6:1, or more than about 7:1, or more than about 8:1—the coprocessed powder can be combined with at least one additional hydrocolloid to provide a mixture of insoluble fiber and total hydrocolloid (the combined amount of the first hydrocolloid and the additional low viscosity hydrocolloid) within the ranges described herein, and thereby improve the palatability of the fiber supplement over that obtained by mixing the hydrocolloid and insoluble fiber in one step. The additional hydrocolloid is at least one of the hydrocolloids described as suitable for use herein, or a mixture thereof.

Combinations of MCC and guar gum were tested to determine the degree of perceived grittiness (from the insoluble MCC) and/or sliminess (from the low viscosity guar gum). It was found that combinations of MCC/guar gum in the range of from about 1:1 to about 1:3 (MCC to guar) had perceptively reduced grittiness and an acceptable degree of perceived sliminess.

The compositions or the present invention do not form gels after mixing—even after standing for a period of time—and thereby eliminate the perceived feeling of sliminess or sludginess that is apparent in some conventional fiber supplements currently available on the consumer market.

The combination of soluble and insoluble fiber can further comprise optional components that are included to provide flavor, color, sweetness, and other properties intended to improve the palatability of the mixture.

In a particular embodiment, the fiber supplement can include all natural components. By “all-natural”, it is meant that the components are derived from natural sources of insoluble fiber, with minimal processing used to obtain and/or further process the fiber. Additives from natural sources are acceptable, and no synthetic additives are included.

Fiber compositions of the present invention are intended to be mixed with beverages and foods to supply a portion of the daily recommended fiber dosage. The bulk component with which the fiber is combined is generally referred to as the vehicle. The final percentage of the fiber supplement that is used in a food or beverage can depend on a number of factors—including commercial and manufacturing decisions—but typically will not exceed about 20 wt % of the food or beverage mixture.

The powder mixture can be mixed with any compatible delivery vehicle. While water is the most prominent vehicle for mixing, other combinations are considered to be within the scope of the present invention. For example, the powder mixture can be mixed with: dairy products such as milk, yogurt, puddings and shakes; beverages such as fruit smoothies, juices, teas, flavored water; baked goods such as bread, cookies, and brownies; frozen treats, such as ice cream, sorbets; and dessert bars, protein bars, dressings and sauces. The powder mixtures of the present invention can be included in hot liquids, cold liquids and beverages, including beverages that are derived from plant sources. By “hot” it is meant that a beverage or food item is prepared and/or served by heating the beverage or food above prevailing room temperature conditions (ambient temperature). By “cold” it is meant that a beverage or food item is prepared and/or served by cooling the beverage or food below ambient temperature. One of ordinary skill in the art or food preparation would reasonably know what beverages and food items are typically prepared or served at temperatures above or below ambient conditions.

### EXAMPLES

### Example 1

### Mixed Berry Sweetened with Sugar

MCC powder and guar gum powder were combined in a weight ratio of 1:1. The powder mix was further combined with mixed berry flavoring and sugar. The mixture was dry-blended to provide the flavored MCC/guar fiber source.

### Example 2

### Mixed Berry Sweetened with Stevia and Monk Fruit

MCC powder and guar gum powder were combined in a weight ratio of 1:1. The powder mix was further combined with mixed berry flavoring, stevia and monk fruit. The mixture was dry-blended to provide the flavored MCC/guar fiber source.

### Example 3

### Tropical Orange Sweetened with Sugar

MCC powder and guar gum powder were combined in a weight ratio of 1:1. The powder mix was further combined with color and sugar. The mixture was dry-blended to provide the flavored MCC/guar fiber source.

### Example 4

### Tropical Orange Sweetened with Stevia and Monk Fruit

MCC powder and guar gum powder were combined in a weight ratio of 1:1. The powder mix was further combined with color, stevia and monk fruit. The mixture was dry-blended to provide the flavored MCC/guar fiber source.

### Example 5

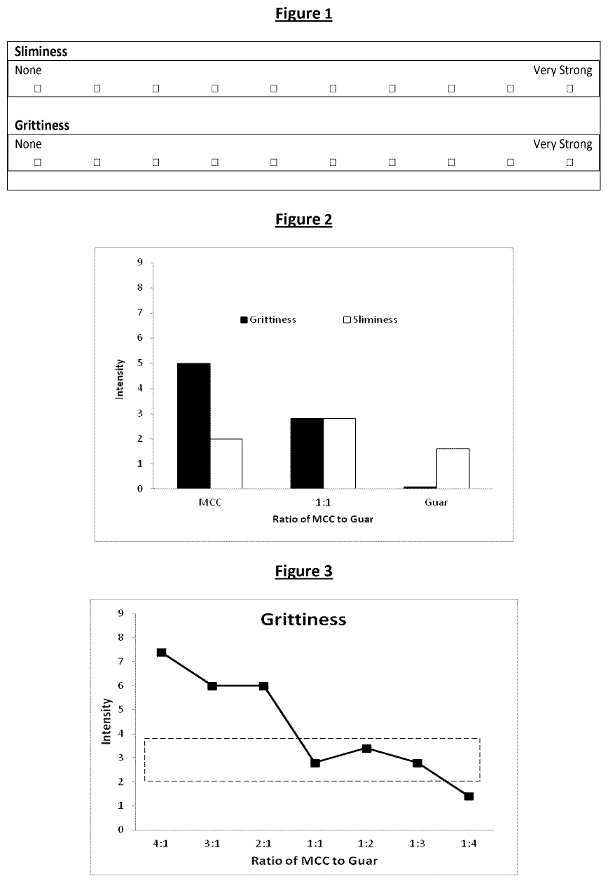

Grittiness and sliminess intensity were assessed by five participants on a ten point category scale, as shown in FIG. 1.

Participants rated nine samples, MCC alone, guar gum alone, and seven ratios of MCC and guar gum mixed as follows:

TABLE 1

| | MCC | 4:1 | 3:1 | 2:1 | 1:1 | 1:2 | 1:3 | 1:4 | Guar |
|---|---|---|---|---|---|---|---|---|---|
| MCC (g) | 4 | 6.4 | 6 | 5.3 | 4 | 2.7 | 2 | 1.6 | 0 |
| Guar Gum (g) | 0 | 1.6 | 2 | 2.7 | 4 | 5.3 | 6 | 6.4 | 4 |

Samples were presented unidentified to panelists, with each panelist rating the samples in a unique random order. Scores were averaged across the panelists, and results are shown below.

At a roughly 1:1 ratio of MCC to guar, the perceived grittiness of MCC is reduced, without a notable increase in perceived sliminess, that is, without an increase of more than 2 intensity units, as shown in FIG. 2 and FIG. 3.

At ratios with more MCC than guar, perceived grittiness was not masked. (FIG. 3)

### Example 6

The fiber mixture of Example 3 was compared to PureLean® Fiber Powder by Pure Encapsulations. One serving of each, 23 g of Example 3 and 2 Scoops (Approximately 14.4 Grams) of PureLean, was dispersed in 8 ounces of filtered water.
PureLean® Fiber Powder by Pure Encapsulations
Total Carbohydrate 8 g
Dietary Fiber 6 g
Protein 1 g
Magnesium (As Magnesium Citrate) 100 mg
Sodium (Naturally Occurring) 16 mg
PreticX™ Xylooligosaccharides 700 mg
Proprietary Fiber Blend 10 g
   CreaFibe cellulose, Sunfiber® partially hydrolyzed guar gum, flax seed fiber, 1,000 mg glucomannan, prune fruit powder, apple pectin
Other Ingredients: Xylitol, luo han guo (momordica grosvenori) extract (fruit).

### Methods

One serving of product was dispersed in 8 ounces of filtered water in a salad dressing mixer with a whisk ball. Upon arrival, both products were shaken to redistribute the dispersion and 1 ounce was poured into a 4-ounce solo cup. Panelists were asked to taste both samples in a paired preference test. They were instructed to swirl the content of each cup immediately before tasting and then select which of the two samples was more palatable. A total of 31 panelists participated. Half of the panelists began by tasting the mixture obtained from Example 3 and half tasted in the reverse order.

### Analysis

Whether or not a significant proportion of the population preferred one product over the other was determined by use of a two-tailed binomial test.

### Results

25 of the 31 participants, or 81%, preferred Example 3 to PureLean Fiber which is significant at p=0.001. This indicates a significant proportion of the population prefers the mixture of the present invention, as this outcome would only occur by chance once every 1000 tests.

### Example 7

Several commercially available fiber supplements were evaluated for viscosity increase after mixing with water. The manufacturer's recommended dosage of fiber supplement was stirred in 8 oz. of filtered water for 15 seconds. The viscosity of the resulting mixture was measured in centipoise (cps) using a Brookfield Viscometer, Model: RVT in a 400 mL beaker. After 5 minutes, the fiber mixture was stirred for 15 seconds and its viscosity was measured again. Given the wide range in viscosity across products, different spindles and speeds were used in order to ascertain accurate viscosity measurements. The conditions were chosen as follows:
1) for viscosity of less than 100 cps, Spindle #1 at 100 RPM;
2) for viscosity of from 100 to 200 cps, Spindle #1 at 50 RPM;
3) for viscosity of from 200-20,000 cps, Spindle #1 at 0.5 RPM; and
4) for viscosity of from 20,000-40,000 cps, Spindle #2 at 1 RPM.

Table 2 lists (i) the fiber components of each product sample evaluated, (ii) the total soluble (Sol) fiber and total insoluble (Insol) fiber content of each, and (iii) the change in viscosity measured for each product sample.

TABLE 2

| Name/ | | Sol | Insol | Viscosity (cps) | | |
|---|---|---|---|---|---|---|
| Dosage | Fiber | Fiber | Fiber | at | at | |
| (grams) | Ingredients | (g) | (g) | 0 min | 5 min | Change |
| Metamucil | psyllium | 5 | 1 | 110 | 26400 | 26290 |
| Orange | | | | | | |
| Smooth/12 | | | | | | |
| Metamucil | psyllium | 5 | 1 | 113 | 24800 | 24687 |
| Orange | | | | | | |
| Smooth SF/5.8 | | | | | | |
| Konsyl | psyllium | 3 | 2 | 128 | 15400 | 15272 |
| Psyllium | | | | | | |
| Fiber/6 | | | | | | |
| PureLean | cellulose, guar | 3.5 | 3 | 13.5 | 27.5 | 14 |
| Fiber/14.4 | gum, | | | | | |
| | flax seed fiber, | | | | | |
| | glucomannan, | | | | | |
| | prune fruit | | | | | |
| | powder, pectin | | | | | |
| Citrucel/19 | methylcellulose | 2 | 0 | 30 | 156 | 126 |
| MiraFiber/19 | methylcellulose | 2 | 0 | 90 | 1380 | 1290 |
| Benefiber/4 | wheat dextrin | 3 | 0 | 6 | 8 | 2 |
| Example 3/23 | cellulose, guar | 3.5 | 3.5 | 10 | 11.5 | 1.5 |
| | gum | | | | | |
| Dr Natura | cellulose | 0 | 3 | 38 | 80 | 42 |
| UniFiber/4 | | | | | | |
| Vital | cellulose | 0 | 15 | 11 | 10 | −1 |
| Nutrients | | | | | | |
| Cellulose | | | | | | |
| Fiber/15 | | | | | | |
| Nutricology | cellulose | 0 | 2 | 3.5 | 7 | 3.5 |
| Dietary Fiber | | | | | | |
| Cellulose/2 | | | | | | |

It can be observed from the Table 2 that conventional products that include both soluble and insoluble fiber have a substantial viscosity increase upon mixing with water.

1. A composition suitable for use as a dietary fiber supplement, the composition comprising:
a) a microcrystalline cellulose;
b) a low viscosity guar gum having a viscosity below about 50 cps; and
c) water;
wherein the weight ratio of microcrystalline cellulose to guar gum is from about 4:1 to about 1:4; and
wherein the viscosity of the composition is from about 5 cps to about 30 cps, and the composition does not form a gel.

2. The composition of claim 1 wherein the weight ratio of microcrystalline cellulose to guar gum is from about 1:1 to about 1:3.

3. The composition of claim 1 wherein the composition further comprises additives selected from the group consisting of acidulants, fruit powders, sweeteners, colorants, bulking agents, and flavorings.

4. The composition of claim 1 comprising an additional hydrocolloid selected from the group consisting of: guar gum; gum acacia; beta-glucan soluble fiber; pectin; locust bean gum; hydroxypropylmethylcellulose; agar; alginates; propylene glycol alginate; carrageenan; starch; xanthan; gellan; konjac gum; dextran; pullulan; ghatti; karayan gum; fullcellaran; larch gum; tara gum; tamarind seed gum; tragacanth; curdlan; carboxymethylcellulose (CMC); methylcellulose (MC); ethylcellulose (EC); hydroxypropylcellulose (HPC); Na-CMC—cellulose gum; arabinoxylan; curdlan; gelatin; and mixtures of any of these.

5. The composition of claim 1 wherein the microcrystalline cellulose is present in a concentration of about 50 wt % or less of the composition.

6. The composition of claim 1 wherein the viscosity of the composition is from about 5 cps to about 20 cps.

7. A food or beverage comprising the composition of claim 1.

8. The food or beverage of claim 7 selected from the group consisting of dairy products; fruit smoothies; juices; teas; flavored water; baked goods; frozen treats; dessert bars; protein bars; dressings; and sauces.

9. A method for the production of a composition suitable for use as a dietary fiber comprising:
a) dry-blending a water insoluble cellulose-based polymer with at least one low viscosity hydrocolloid to form a dry powder wherein the ratio of cellulose-based polymer to hydrocolloid is from about 4:1 to about 1:4; and
b) combining the dry powder of step a) with water to form an aqueous mixture, wherein the viscosity of the aqueous mixture is from about 5 cps to about 30 cps, and the aqueous mixture does not form a gel.

10. The method of claim 9 wherein the cellulose-based polymer is microcrystalline cellulose.

11. The method of claim 9 wherein the hydrocolloid is selected from the group consisting of: guar gum; gum acacia; beta-glucan soluble fiber; pectin;
locust bean gum; hydroxypropylmethylcellulose; agar; alginates; propylene glycol alginate; carrageenan; starch; xanthan; gellan; konjac gum; dextran; pullulan; ghatti; karayan gum; fullcellaran; larch gum; tara gum; tamarind seed gum; tragacanth; curdlan; carboxymethylcellulose (CMC); methylcellulose (MC); ethylcellulose (EC); hydroxypropylcellulose (HPC); Na-CMC—cellulose gum; arabinoxylan; curdlan; gelatin; and mixtures of any of these.

12. The method of claim 9 wherein at step a) an additional hydrocolloid is dry-blended with the cellulose-based polymer.

13. The method of claim 9 wherein the viscosity of the aqueous mixture is from about 5 cps to about 20 cps.

14. The method of claim 9 wherein at step b) the composition does not exhibit a substantial increase in viscosity for at least five minutes after the dry powder is combined with water.

15. A powdered composition suitable for use in a dietary fiber supplement, the composition comprising:
(i) a microcrystalline cellulose; and
(ii) a guar gum having a viscosity below about 50 cps;
wherein the microcrystalline cellulose (i) and the guar gum (ii) are combined in a weight ratio in the range of from about 4:1 to about 1:4;
wherein the powdered composition does not form a gel with water.

16. The powdered composition of claim 15, wherein the microcrystalline cellulose (i) and the guar gum (ii) are combined in a weight ratio in the range of from about 1:1 to about 1:3.
